(19) United States
(12) Patent Application Publication
(10) Pub. No.: US 2016/0191324 A1
(43) Pub. Date: Jun. 30, 2016

(54) SUBSEQUENT ADDRESS FAMILY IDENTIFIER FOR SERVICE ADVERTISEMENTS

(71) Applicant: vIPtela Inc., San Jose, CA (US)

(72) Inventors: Lars Olof Stefan Olofsson, Dubai (AE); Nehal Bhau, San Jose, CA (US); Himanshu H. Shah, Milpitas, CA (US)

(21) Appl. No.: 14/583,543

(22) Filed: Dec. 26, 2014

(51) Int. Cl. H04L 12/24; H04L 12/813; H04L 12/733

(52) U.S. Cl. CPC H04L 41/12; H04L 45/20; H04L 41/0803; H04L 47/20

(57) ABSTRACT

A method for routing network traffic between network elements within a computer network is disclosed. The method comprises configuring the computer network to include a control plane and a forwarding plane; configuring each network element of the forwarding plane to periodically compose and transmit a control plane protocol message to every other network element of the forwarding plane, said control plane message comprising network, next-hop; and service information; via the control plane, provisioning at least some of the network elements with at least one policy to control routing of the network traffic based on at least one service; and processing the network traffic by the network elements of the forwarding plane based on the at least one policy.

### FIELD

Embodiments of the present invention relate to networking.

### BACKGROUND

In the Internet and other provider or enterprise network deployments, the commonly taken approach is to use an Interior Gateway Protocol (IGP), (e.g. OSPF, IETF RFC2328, or ISIS, IETF RFC 1195) to carry routing information that pertains to the network topology of a routing domain and an Exterior Gateway Protocol (EGP) (BGP, IETF RFC4271) for carrying routing information that is external to the specific network domain or routing information that pertains to services. With very few, if any, exceptions, BGPv4 is the only EGP that is deployed in networks today for the purpose of sharing information between routing domains (a.k.a. Autonomous Systems) or carrying routing information that is not specifically local to the routing domain. In this capacity, BGPv4 carries the following types of routing information:

a) Reachability to customer networks of the local routing domain

b) Inter-domain routes learned from other service providers

c) Prefixes representing services located in internal data centers

d) Prefixes representing services residing in other service provider networks

e) VPN-instance routing information

f) Routing information describing the Internet

g) and more

In other words, the BGPv4 protocol is what makes up the core of what is usually referred to as the routing system in many pieces of networking literature.

Due to its widespread use and the time over which the protocol has evolved, it has been extended with many features where the most prominent element from an application specific aspect involves a very strong set of policy creation functions and some prefix identification functionality. The prefix identification functions are mostly related to identifying the source of a prefix, although the community feature (IETF RFC1997) allows for an administrator to assign arbitrary tags to prefixes. The challenge with the community is that it is at best considered in a very simple fashion in the BGPv4 best path selection algorithm (ref. IETF draft-retana-bgp-custom-decision-02) and cannot be used to represent specific attributes of a route other than identification or simple preference.

Another challenging aspect of BGPv4 is that each prefix must be advertised with a directly associated next-hop attribute, where the next-hop itself does not carry any attributes that can influence the selection of a certain path for a given prefix. It is also difficult to associate a prefix or a set of prefixes with a network service or a set of chained services due to the nature of the direct association between the BGPv4 prefix and the next-hop that must be provided indiscriminately by the underlying IGP unless a given BGP-speaker uses a directly connected interface for establishing the required BGP-sessions with its neighbor.

With BGPv4 being the prevailing protocol in use for the purpose of advertising services, some overall basic restrictions that make it challenging to use in a situation where intelligent linkage between routing information and services is required, must be addressed for this obstacle to be removed.

A requirement that is emerging very strongly is the ability to identify, advertise and chain network services together to transparently force network traffic to be subject to various services as it traverses the network.

### SUMMARY

According to a first aspect of the invention, there is provided a method for routing network traffic between network elements within a computer network. The method comprises configuring the computer network to include a control plane and a forwarding plane; configuring each network element of the forwarding plane to periodically compose and transmit a control plane protocol message to every other network element of the forwarding plane, said control plane message comprising network, next-hop; and service information; via the control plane, provisioning at least some of the network elements with at least one policy to control routing of the network traffic based on at least one service; and processing the network traffic by the network elements of the forwarding plane based on the at least one policy.

Other aspects of the invention will be apparent from the detailed description below.

### BRIEF DESCRIPTION OF THE DRAWINGS

FIG. 1 shows a network deployment with a centralized control plane.

FIG. 2 shows a network deployment with a distributed control plane.

FIG. 3 shows the default routing state for the network of FIG. 2

FIG. 4 shows routing table information for the network of FIG. 2 in the case where policy is used route all traffic to the network element NE1 via a Service 1

FIG. 5 illustrates forwarding on a service router SR1 of the network of FIG. 2.

FIG. 6 illustrates a structure for a routing update message, in accordance with one embodiment of the invention.

FIG. 7 shows a process for composing a routing update message by the network element NE1, in accordance with one embodiment of the invention.

FIG. 8 shows a process for processing a routing update message by the network element NE1, in accordance with one embodiment of the invention.

FIG. 9 shows a process for switching traffic to another service location by the network element NE1 upon receiving a service failure update, in accordance with one embodiment of the invention.

FIG. 10 shows a high-level block diagram for an overlay controller, in accordance with one embodiment of the invention.

FIG. 11 shows a high-level block diagram of hardware for a router, in accordance with one embodiment of the invention.

### DETAILED DESCRIPTION

In the following description, for purposes of explanation, numerous specific details are set forth in order to provide a thorough understanding of the invention. It will be apparent, however, to one skilled in the art that the invention can be practiced without these specific details. In other instances, structures and devices are shown in block or flow diagram form only in order to avoid obscuring the invention.

Reference in this specification to “one embodiment” or “an embodiment” means that a particular feature, structure, or characteristic described in connection with the embodiment is included in at least one embodiment of the invention. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to the details are within the scope of the present invention. Similarly, although many of the features of the present invention are described in terms of each other, or in conjunction with each other, one skilled in the art will appreciate that many of these features can be provided independently of other features. Accordingly, this description of the invention is set forth without any loss of generality to, and without imposing limitations upon, the invention.

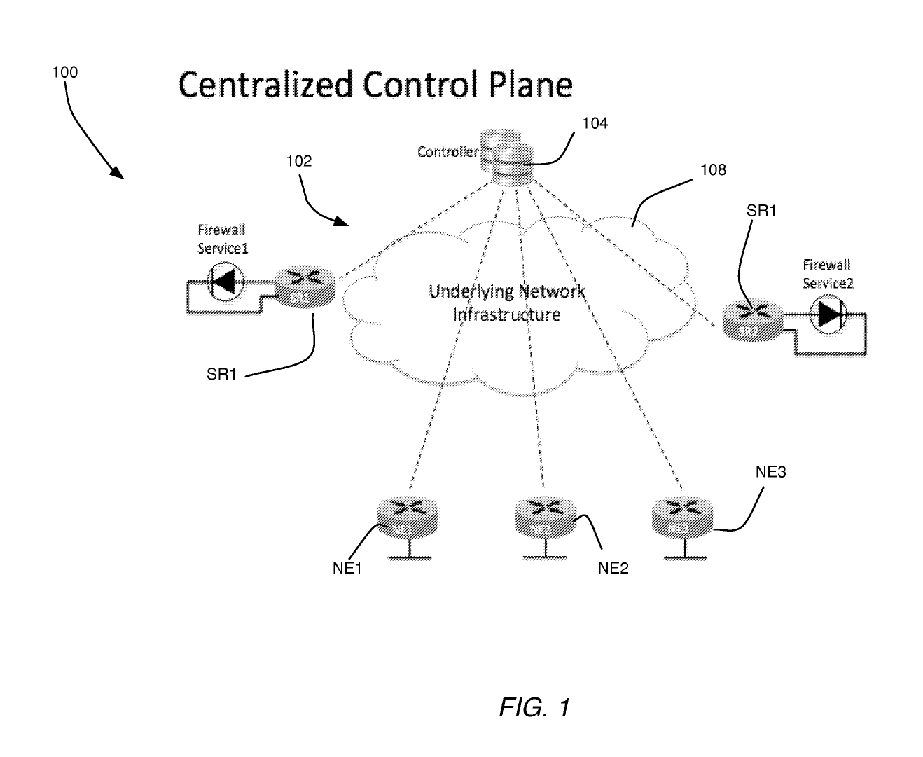

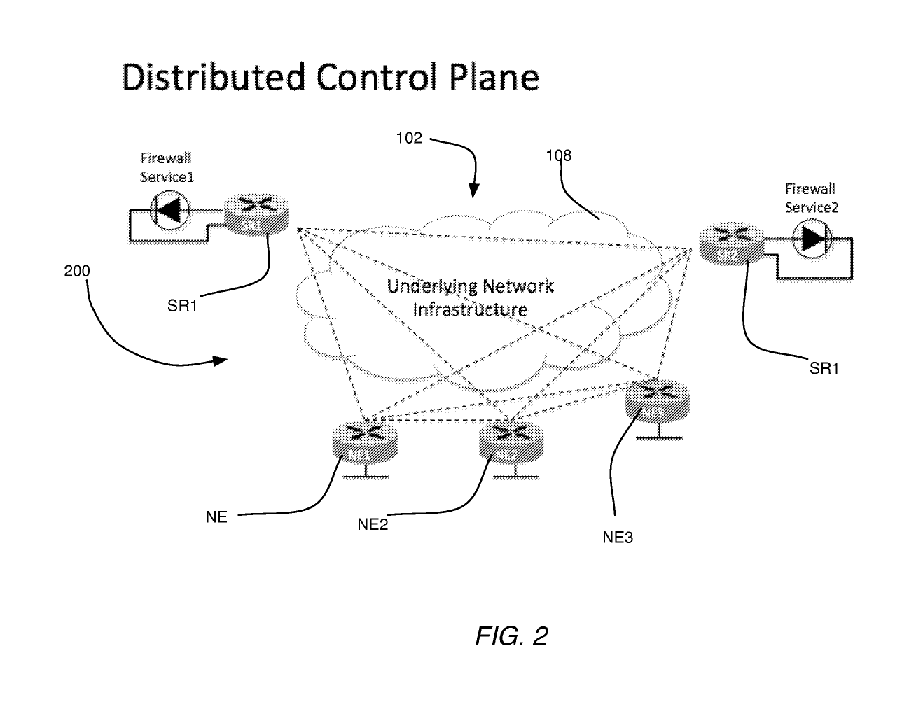

FIGS. 1 and 2 show exemplary networks 100 and 200, respectively, for practicing embodiment of the invention. Referring to FIG. 1, an overlay network 102 includes a centralized overlay controller 104, and a plurality of overlay edge routers designated NE1 to NE3. Although only three edge routers have been shown, it is to be understood that this is intended to be exemplary only, and is thus not intended to be limiting of the number of edge routers within the networks 100 and 200. The overlay controller 104 is configured to orchestrate the overlay network 102 using a secure transport (TLS, Transport Layer Security, IETF RFC5246) and a designated overlay control plane protocol over underlying network infrastructure 108. In one embodiment, the network infrastructure 108 may include a public network such as the Internet. The overlay control plane protocol may operate in a similar fashion to BGP (IETF RFC4271), in functions related to route and policy distribution, reliable transport over TCP (IETF RFC793), and optimal path selection process and distributed state creation. In one embodiment, the overlay control protocol may be the Overlay Management Protocol described in co-pending U.S. patent application Ser. No. 14/133,558 entitled “OVERLAY MANAGEMENT PROTOCOL FOR SECURE ROUTING BASED ON AN OVERLAY NETWORK” which is incorporated herein by reference in its entirety

In one embodiment, in order for the overlay control plane protocol to provide a functional architecture, it distributes overlay routes that are learned from each location where an overlay network element is present, together with external addresses used as next-hop addresses for the overlay routes. The external addresses may be assigned to the physical interfaces of the overlay network elements that attach to the underlying network 108.

The overlay routes may only be accessed through the overlay network 102 and the next-hop addresses can only be reached through the underlying network 108. Together, the overlay routes and next-hop addresses provide for a complete and functional overlay architecture. As far as the underlying network 108 is concerned, the only element used to forward traffic between the sites is the next-hop address. The underlying network 108 does not know about any other routes, addresses or labels that may be used for providing a functional network infrastructure within the overlay network 102 itself.

Secure tunnels are established between the next-hop addresses, which define the elements (hubs or edges) that actually instantiate the overlay network 102. The secure tunnels define a control plane, as shown in FIG. 1. Thus, all traffic that use the overlay network 102 for transport is carried within this topology of tunnels.

In one embodiment, within the overlay network 102, the overlay controller 104 processes control plane traffic, but does not get involved in the processing of data traffic. All data traffic is processed by the network elements present at site locations, such as a branch office, or central locations, such as a data center or a headquarters location. The network elements may represent edge routers, e.g. in the case of a branch location, or service routers, e.g. in the case of a location where a service is located. As can been seen from FIG. 1, network elements SR1 and SR2 are locations at which firewall services are provided, whereas network elements NE1 to NE3 represent routers to various network prefixes. In one embodiment, secure peer-to-peer links between the network elements (excluding the centralized controller 104) define a forwarding plane.

Referring now to FIG. 2, the network deployment 200 is similar to the network deployment 100 in all respects save that instead of a centralized control plane there is now a distributed control plane.

Embodiments of the invention disclose techniques for identification and advertisement of services within the networks 100 and 200. Said techniques use Service Subsequent Address Family Identifier (Service SAFI) in control plane protocol updates to provide the ability for every network element to properly identify, learn the current status of, and use services in central or local policy constructs. The use of a specified SAFI for services circumvents any dependency on given services being available or even being present. Prefixes in a routing table are free to use any available path and having traffic being subject to services is a decision that can be made dynamically and based on priority.

Identification of services may be managed by establishing a common notation for different types of services that is defined within the Service SAFI specification shared and implemented in every participating node. A sample list of services may include the following, but any type of service could be advertised using this mechanism:

TABLE 1
Service types

| Service Type | Identifier (enum) |
|---|---|
| Firewall | 0x0001 |
| Intrusion Detection System | 0x0002 |
| Deep Packet Inspection | 0x0003 |
| Caching System | 0x0004 |

Once a service advertisement and the connectivity to the given service has been configured on a local network element, the network element will advertise the service using the Service SAFI to identify the service as discussed above and also provide reachability information for the service to be used by the receiving network elements. A given service advertisement may be composed as below:

FIG. 1: Service SAFI protocol format

| | | | | |
|---|---|---|---|---|
| Bit offset | 0-7 | 8-15 | 16-23 | 24-31 |

| 0 | Length | Service Type |
|---|---|---|
| 32 | Prefix or Label | |
| 64 | VPN-Id | Status |

| | |
|---|---|
| 96 | Originator |

The length indicates the length of the SAFI entry as it could vary due to how many services are advertised in a given update. Service-type is as discussed above and the service could be represented by either a prefix or a label. In case the access to a service is to be restricted to a given Virtual Private Network (VPN) then a VPN identifier is also provided. The status of a service may reflect mere presence but also other conditions such as load and health. Additionally, the originator field serves to provide information about the control plane protocol identity of the node advertising the service. Not all fields may be required for certain implementations and fields may be added as required, potentially for certain services. The size of certain fields may also vary, e.g. it could be required to substitute the 32-bit originator field with a 128-bit field in case the originator is identified by an IPv6 address (IETF RFC4291).

A network element in a location where a service is hosted may be configured to advertise the service and may be instructed to do so either permanently or dependent or the current state of the local service. For example, if a locally configured firewall is operational the service is advertised but otherwise withdrawn.

Since actual prefix information is carried separately from the service SAFI, it is up to either the originator or receiver of the control protocol update to determine if the use of a certain service is required for a given prefix or set of prefixes. Advantageously, there is no direct dependency on a service being present or being provided from a certain location. Policy in an ingress network element can determine whether or not any service of a given type (e.g. a firewall service) is sufficient or the service has to be provided from a given location. This provides flexibility from a redundancy point of view, as one firewall service can substitute another and it's yet another benefit of the architectural choice of separating prefixes and services in the protocol updates.

Advantageously, as the network elements are equipped with service information it also allows for additional service aware functions to be implemented, such as proximity routing for services, preferential treatment, availability checking, abstraction of location and other service attributes as well as other service specific functions

The use of a Service SAFI in a deployed network environment may involve the following components:

(a) a network element originating the advertisement of a service—e.g. the network elements SR1 and SR2;

(b) an operational service (e.g., a firewall service);

(c) a set of network elements originating prefix information and also providing inbound connectivity to the network domain—e.g. the edge router NE1 to NE3; and

(d) policy constructs enforced on the inbound network elements that may be configured and enforced locally or configured on a central controller and then distributed for local enforcement on the inbound network elements.

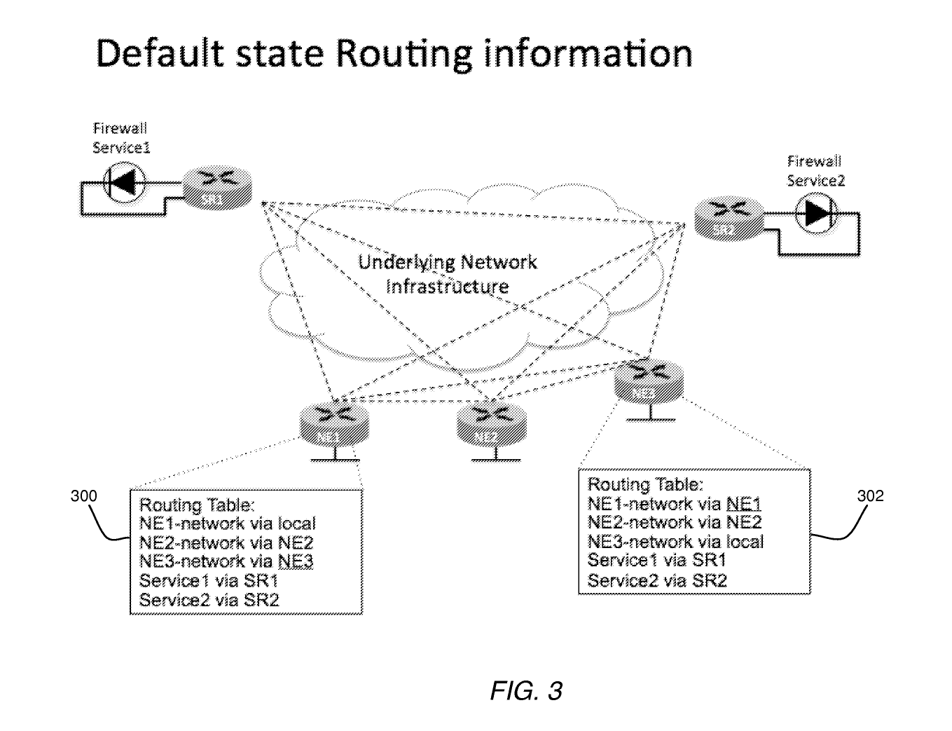

FIG. 3 of the drawings shows the routing information corresponding to a default state for the network 200. In particular, the routing information for the default state includes a routing table 300 for the network element NE1 and a routing table 302 for the network element NE2.

As will be seen that routing table 300 shows that NE1 network is a local network, the network NE2 is reachable via NE2, the network NE3 is reachable via NE3, firewall Service 1 is reachable via SR1, and firewall Service 2 is reachable via SR2.

Likewise, the routing table 302 shows that the NE1 network reachable via NE1, the network NE2 is reachable via NE2, the network NE3 a local network, firewall Service 1 is reachable via SR1, and firewall Service 2 is reachable via SR2.

In terms of bring up, the firewall Service 1 is brought up and attached to its local network element (service router SR1) and firewall Service 2 is brought up and attached to service router SR2. Both SR1 and SR2 are configured to advertise their respective local firewall service to all other network elements (NE1 to NE3) using a label for reachability. Techniques for bringing up network elements are described in co-pending U.S. patent application Ser. No. 14/028,518 entitled “SECURE BRING-UP OF NETWORK DEVICES”, which is incorporated herein by reference in its entirety.

The network elements NE1 to NE3 advertise their local prefixes and all other routers in the network, inclusive of SR1 and SR2, and learn routes by means of the control plane protocol. The regular or non-service-providing network elements (NE1 to NE3) install all routes and enforce policy. For illustration purposes, the rest of this description will refer to Policy (P1) that requires all traffic for a certain network element (NE1) to pass through a firewall service. In one embodiment, the policy may be provisioned in the regular network elements by an administrator using the control plane protocol. To implement the policy (P1), the remaining network elements alter the routing table entries for the prefixes learnt from NE1 to point to SR1, since that is the firewall that is available with the lowest distance in protocol terms.

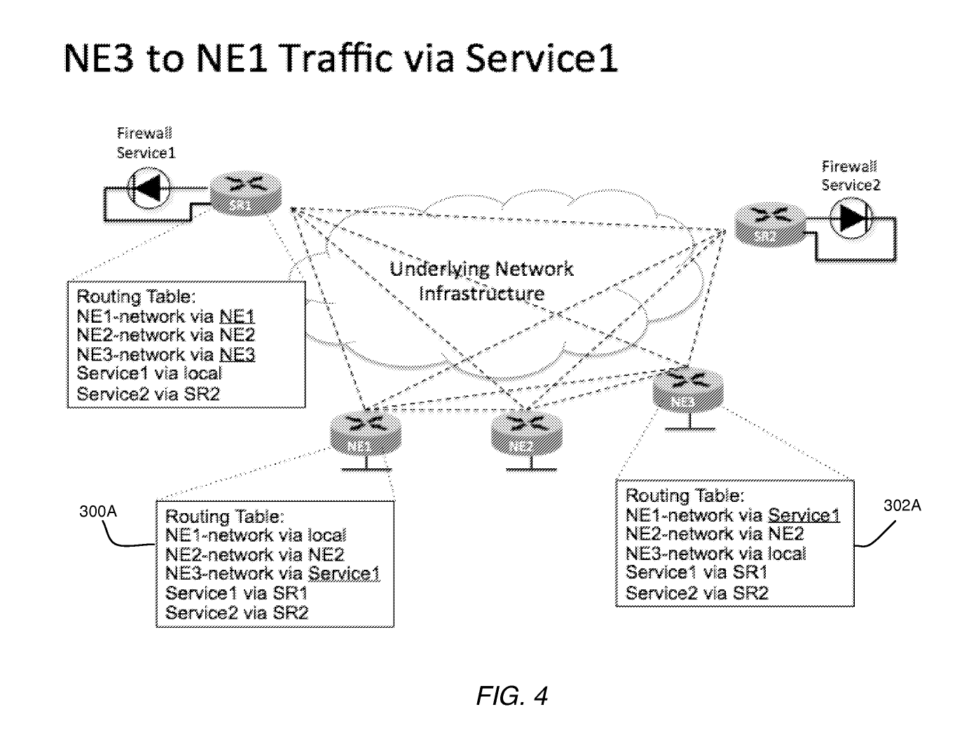

FIG. 4 shows updated routing information for the network 200 after completion of the bring up steps described above. Referring to FIG. 4, routing table 300A corresponds to the routing table 300 after the update and routing table 302A corresponds to the routing table 302 after the update.

As will be seen that routing table 300A shows that NE1 network is a local network, the network NE2 is reachable via NE2, the network NE3 is reachable via Service 1, firewall Service 1 is reachable via SR1, and firewall Service 2 is reachable via SR2.

Further, the routing table 302A shows that the NE1 network reachable via Service 1, the network NE2 is reachable via NE2, the network NE3 a local network, firewall Service 1 is reachable via SR1, and firewall Service 2 is reachable via SR2.

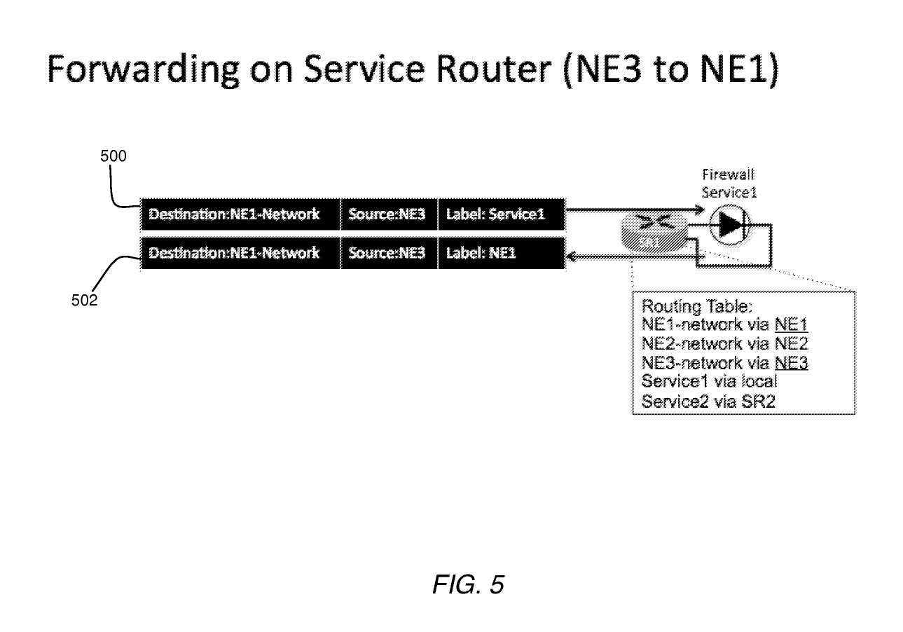

Thus, all the routers will send their traffic bound for NE1 via SR1. At the service router SR1 traffic bound for NE1 will be subjected to the firewall Service 1 that is available at SR1 and then forwarded to NE1. Packet forwarding by the service router SR1 is shown in FIG. 5. Referring to FIG. 5, each inbound packet 500 received at SR1 from NE3 will include the following information:

(a) Destination: NE1;

(b) Source: NE3; and

(c) Label: Service 1.

If the firewall Service 1 at SR1 approves the packet 500 for forwarding to NE1, then SR1 will create an outbound packet 502 for SR1 based on the inbound packet 500 as follows:

(a) Destination: NE1;

(b) Source: NE3; and

(c) Label: NE1.

Later, the firewall goes down at SR1. This will cause SR1 to subsequently withdraw the firewall service advertisement through the control plane protocol. Since the policy (P1) implemented at all the network elements stipulated any firewall and not a specific firewall, the network elements can now install the firewall service advertised by SR2 for use with prefixes originating from NE1. Thus, all the routers now send their traffic bound for NE1 via SR2.

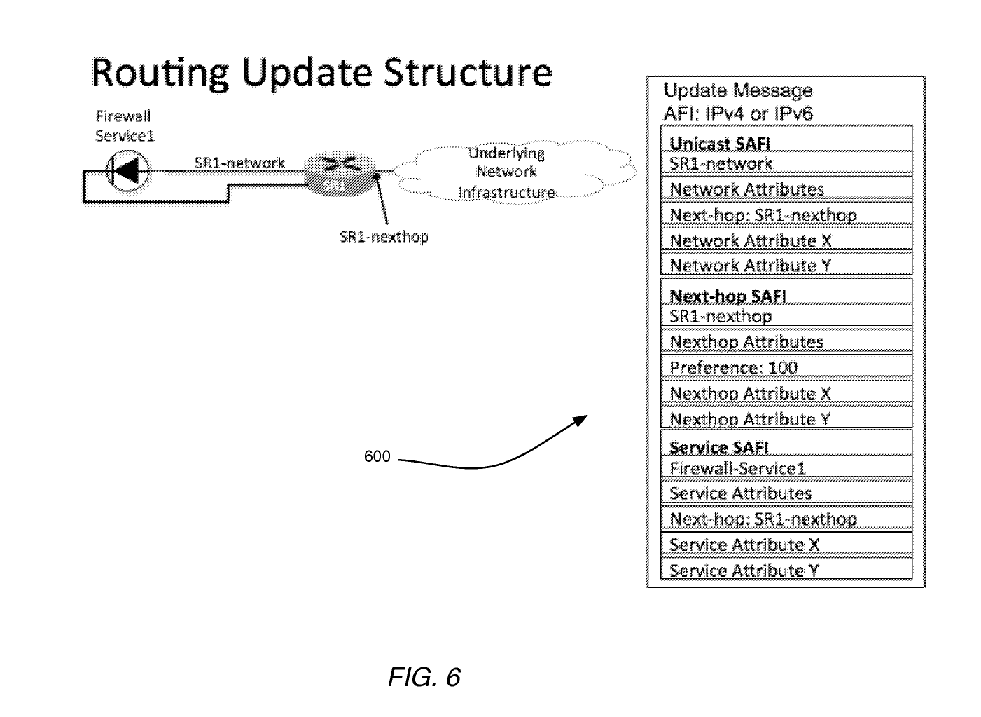

FIG. 6 of the drawings shows how the service information may be included or packaged in control plane updates, in accordance with one embodiment. Referring to FIG. 6, reference numeral 600 indicates a control plane message update originating from a network element, in this case the network element SR1. The message 600 is to advertise SR1 as the next hop for the firewall Service 1. As will be seen, the message 600 is structured to include three portions, namely portions 602, 604, and 606. The portion 602 contains information about the networks to which the network element SR1 is attached. The portion 602 is known as the Unicast SAFI. The portion 604 is the next hop SAFI, and includes information defining the network element SR1 as the next hop for the network SR1. Finally, the component or portion 606 is known as the service SAFI and includes information about the services available at the network element SR1. As will be seen, the service SAFI component includes the firewall Service 1.

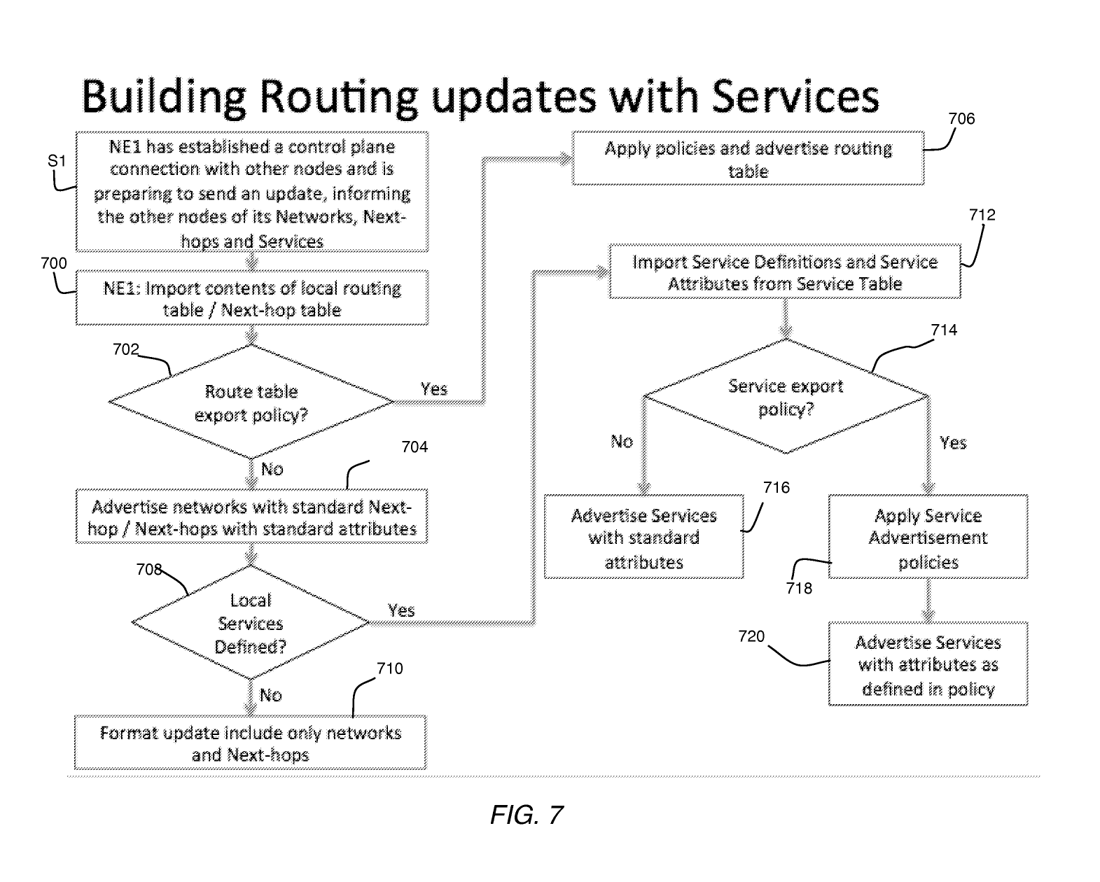

Referring now FIG. 7 of the drawings there shown an exemplary process for building routing update messages. The process outlined in FIG. 7 may be used to build the update message 600 shown in FIG. 6. The process shown in FIG. 7 may be executed by any of the network elements SR1, SR2, or NE1 to NE3. However, for illustrative purposes the operations shown in FIG. 7 are described as being executed by the network element NE1. Referring to FIG. 7, block S1 shows the state of the network element NE1. As will be seen, the network element NE1 is in a state in which it has established a control plane connection with other nodes of the network and is preparing to send an update informing the other nodes of its networks, next-hops and services. At block 700, NE1 imports the contents of a local routing table. At block 702, NE1 checks if it has been provisioned with a routing table export policy. If NE1 has not been provisioned with a routing table export policy, then block 704 executes, otherwise control passes to block 706. In block 706 the export policy is applied and the routing table is advertised. At block 704, NE1 advertise its networks with standard next hop/next-hops with standard attributes. At block 708 NE1 checks if local services have been defined. If no local services have been defined then at block 710, NE1 formats an update to include only networks and the next hops. The update is then sent to the other nodes of the networks using the control plane protocol. However, if the local services have been defined then at block 712 NE1 imports service definitions and service attributes from a service table. Control then passes to block 714 where a check is made to determine if NE1 has been provisioned with a service export policy. At block 716 if there is no service export policy, then the services are advertised with standard attributes. However, if there is a services export policy, then the policy is applied at block 718 and at block 720 NE1 advertises its services and attribute as defined in the service export policy.

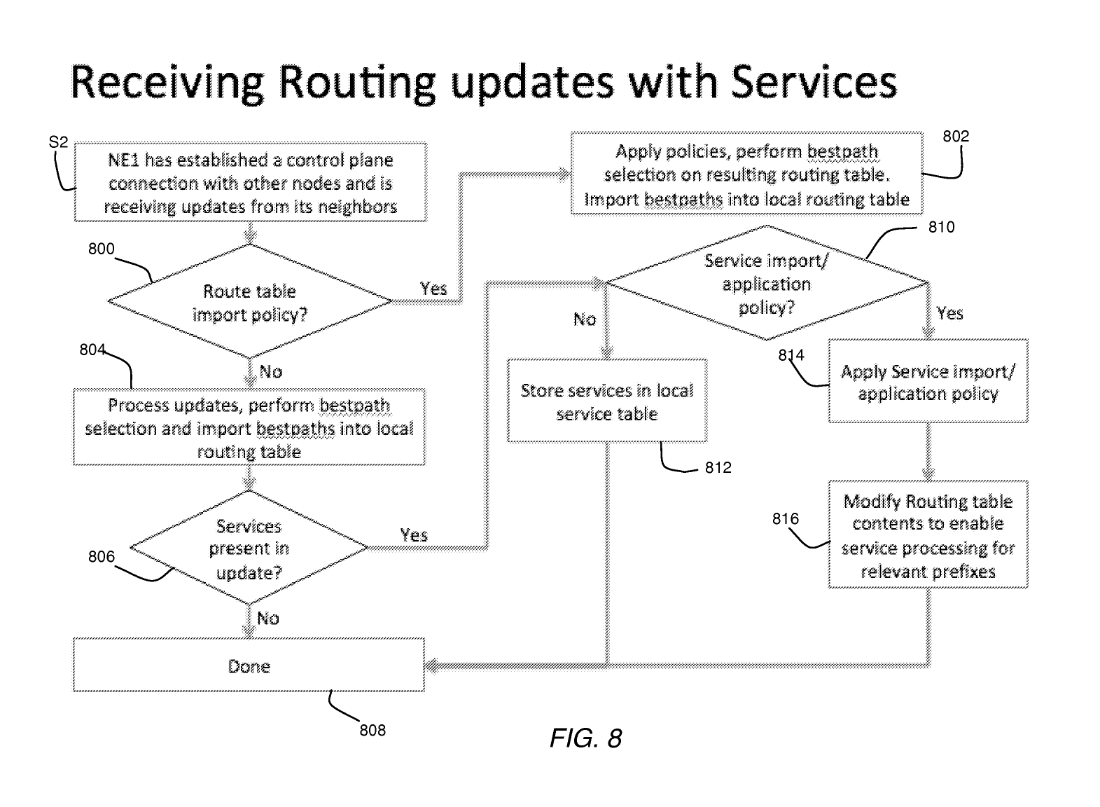

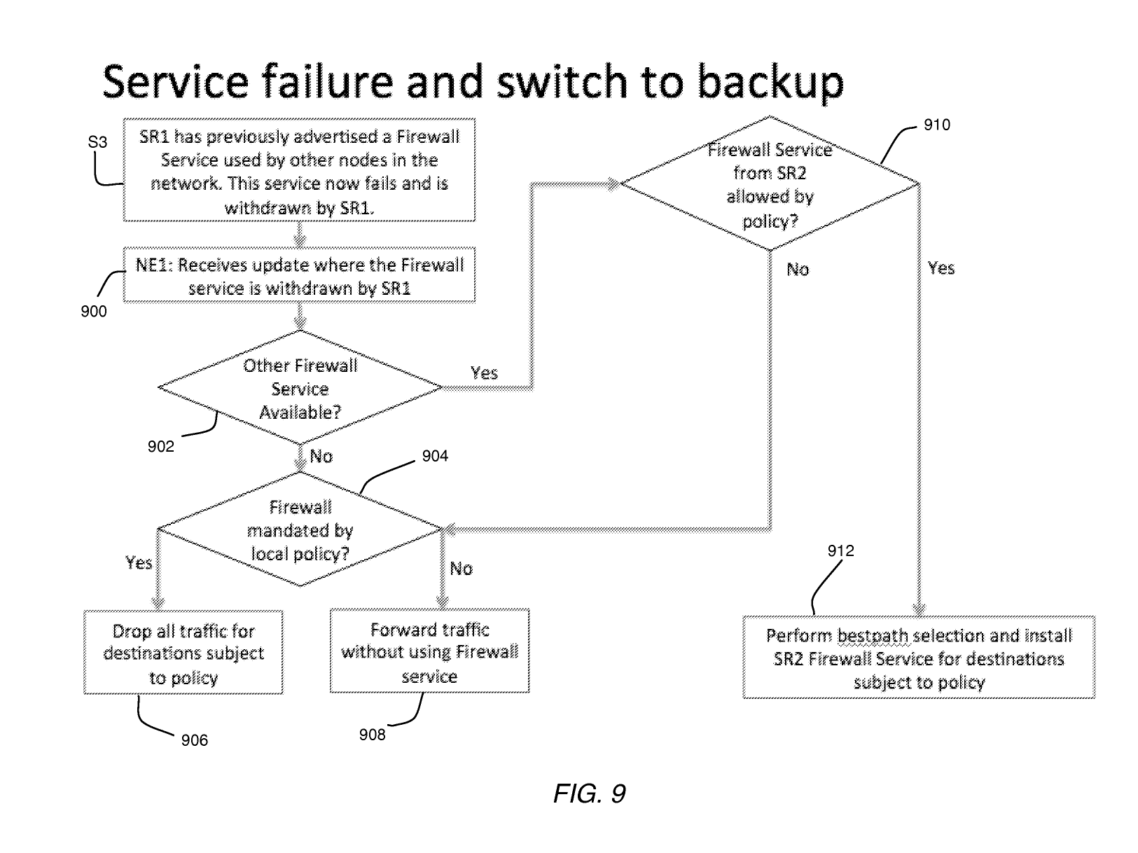

Turning now to FIG. 8 of the drawings there is shown a flow chart of operations performed by NE1 upon receiving a control plane service update. Referring to FIG. 8, the block S2 shows that NE1 is in a state in which it has already established a control plane connection with other nodes and is receiving updates from its neighbors. At block 800 NE1 checks if it has been provisioned with a routing table import policy. If it has, then block 802 executes wherein the routing table import policy is applied. At block 802 NE1 also performs a best path selection on the resulting routing table and imports best paths into a local routing table. If NE1 has not been provisioned with a routing table import policy then block 804 executes. Under block 804 NE1 processes updates and performs best path selection and imports best paths into a local routing table. Control then passes to block 806 where a check is made to determine if there are any services present in the update. If there are no services present in the update then the process ends at block 808. If there are services present in the update, then control passes to block 810 where NE1 determines if it has been provisioned with a service import/application policy. If NE1 determines that it does not have a service import/application policy then at block 812 NE1 stores the services in the update in a local service table. However, if NE1 does have a service import/application policy then at block 814 NE1 applies the service import/application policy and control policy passes to block 816. At block 816 NE1 modifies the routing table contents to enable service processing for the relevant prefixes. As noted above, services are no longer tied to any particular network element. Thus, in the event of service failure at a particular network element, it is possible to seamlessly failover to another network element that provides an equivalent service. This is illustrated in the flow chart of FIG. 9. Referring to FIG. 9, SR1 is in the state S3 where it has previously advertised its firewall service to be used by other nodes in the network, and the firewall service has failed and has thus been withdrawn by SR1 At block 900, the network element NE1 receives an update indicating that the firewall Service 1 have been withdrawn by SR1. At block 902 NE1 checks if other firewall services are available within the network. If there are no other firewall services available then at block 904 NE1 checks if a firewall is mandated by local policy. If it turns out that a firewall service is mandated by local policy then block 906 executes, where all traffic for destinations subject to firewall services are dropped. If firewall services are not mandated by local policy then at block 908 NE1 forwards traffic to other destination nodes within the network without using any firewall service. In the case where other firewall services are available within the network then control from block 902 passes to block 910 where NE1 checks to see if the provision of firewall services by SR2 (the other networks element providing firewall services) is allowed by policy. If it is not then control passes to block 908. However, if policy allows network element SR2 to provide firewall services then control passes to block 912. At block 912 a best path selection is performed and the firewall service at SR2 is installed for all destinations subject to the policy P1 requiring firewall services.

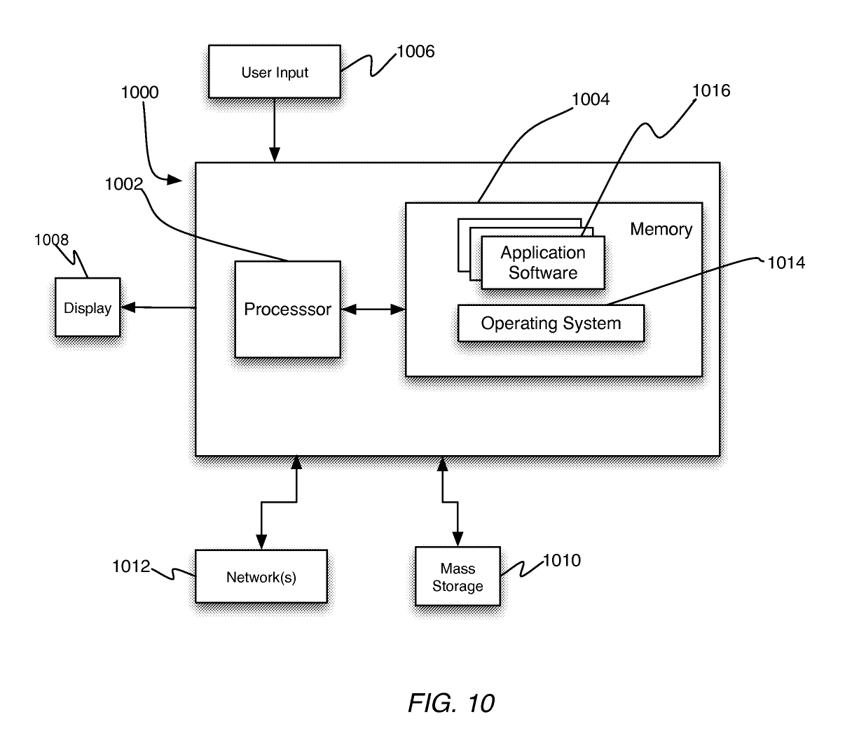

FIG. 10 shows an example of hardware 1000 that may be used to implement the overlay controller 102, in accordance with one embodiment. The hardware 1000 may include at least one processor 1002 coupled to a memory 1004. The processor 1003 may represent one or more processors (e.g., microprocessors), and the memory 1004 may represent random access memory (RAM) devices comprising a main storage of the hardware, as well as any supplemental levels of memory e.g., cache memories, non-volatile or back-up memories (e.g. programmable or flash memories), read-only memories, etc. In addition, the memory 1004 may be considered to include memory storage physically located elsewhere in the hardware, e.g. any cache memory in the processor 1002, as well as any storage capacity used as a virtual memory, e.g., as stored on a mass storage device.

The hardware also typically receives a number of inputs and outputs for communicating information externally. For interface with a user or operator, the hardware may include one or more user input output devices 1006 (e.g., a keyboard, mouse, etc.) and a display 1008. For additional storage, the hardware 1000 may also include one or more mass storage devices 1010, e.g., a Universal Serial Bus (USB) or other removable disk drive, a hard disk drive, a Direct Access Storage Device (DASD), an optical drive (e.g. a Compact Disk (CD) drive, a Digital Versatile Disk (DVD) drive, etc.) and/or a USB drive, among others. Furthermore, the hardware may include an interface with one or more networks 1012 (e.g., a local area network (LAN), a wide area network (WAN), a wireless network, and/or the Internet among others) to permit the communication of information with other computers coupled to the networks. It should be appreciated that the hardware typically includes suitable analog and/or digital interfaces between the processor 1012 and each of the components, as is well known in the art.

The hardware 1000 operates under the control of an operating system 1014, and executes application software 1016 which includes various computer software applications, components, programs, objects, modules, etc. to perform the techniques described above.

In general, the routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, USB and other removable media, hard disk drives, optical disks (e.g., Compact Disk Read-Only Memory (CD ROMS), Digital Versatile Disks, (DVDs), etc.), flash drives among others.

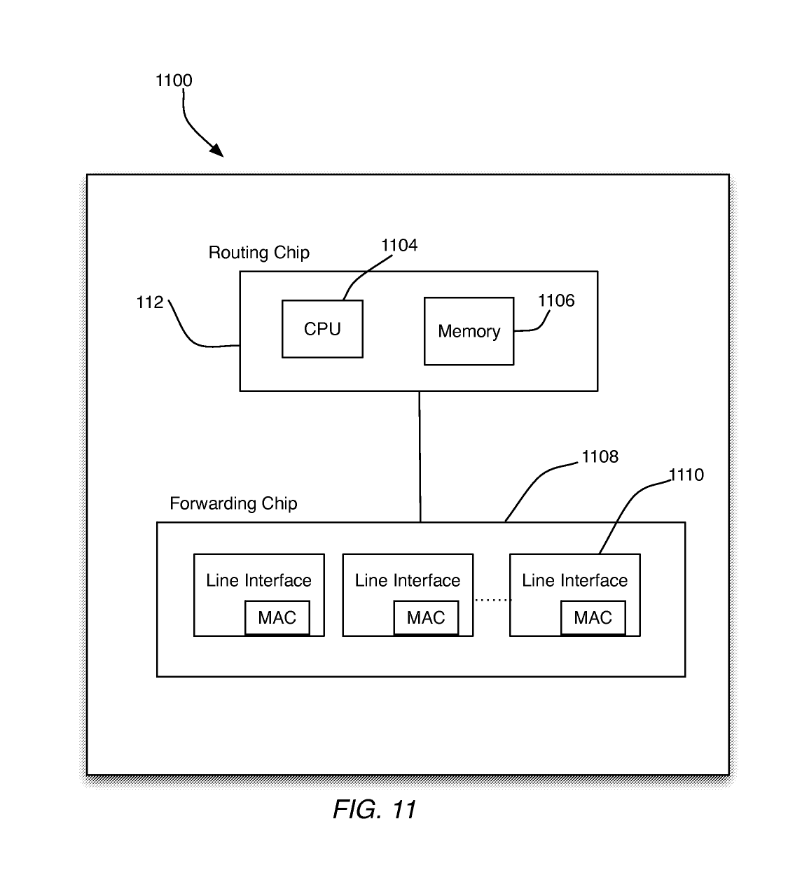

FIG. 11 shows a block diagram of hardware 1100 for any of the elements SR1, SR2, NE1-NE3 described above, in accordance with one embodiment of the invention. Referring to FIG. 11, the hardware 1100 includes a routing chip 1104 coupled to a forwarding chip 1108. The routing chip 1104 performs functions such as path computations, routing table maintenance, and reachability propagation. Components of the routing chip include a CPU or processor 1104, which is coupled to a memory 1106. The memory stores instructions to perform the methods disclosed herein. The forwarding chip is responsible for packet forwarding along a plurality of line interfaces 1110.

Although the present invention has been described with reference to specific exemplary embodiments, it will be evident that the various modification and changes can be made to these embodiments without departing from the broader spirit of the invention. Accordingly, the specification and drawings are to be regarded in an illustrative sense rather than in a restrictive sense.

1. A method for routing network traffic between network elements within a computer network, comprising:
configuring the computer network to include a control plane and a forwarding plane;
configuring each network element of the forwarding plane to periodically compose and transmit a control plane protocol message to every other network element of the forwarding plane, said control plane message comprising network, next-hop; and service information;
via the control plane, provisioning at least some of the network elements with at least one policy to control routing of the network traffic based on at least one service; and
processing the network traffic by the network elements of the forwarding plane based on the at least one policy.

2. The method of claim 1, wherein each policy specifies at least one service to be performed on the network traffic in a manner that is independent of a particular location in the computer network where said at least one service is available.

3. The method of claim 1, wherein said service information is in a Service SAFI component of the control plane message.

4. The method of claim 1, wherein each control message comprises reachability information for any service associated with an originator of said control message.

5. The method of claim 1, wherein each control message comprises state information for any service advertised in said control information.

6. The method of claim 1, further comprising configuring each network element of the forwarding plane to process said control plane message based on a service import policy.

7. The method of claim 1, further comprising configuring each network element of the forwarding plane to, upon receiving a control plane message indicating that a service previously available is no longer available, identify availability of a similar service in the computer network at another location the computer network.

8. The method of claim 8, further comprising configuring said network element to direct network traffic to said other location if policy allows it.

9. The method of claim 7, further comprising configuring said network element to drop network traffic mandated by policy to be routed subject to the service.

10. The method of claim 1, wherein inbound traffic received at a network element of the forwarding plane comprises a destination prefix and is decoupled from reachability information for a service associated with said inbound traffic.

11. A computer network, comprising:
a control plane and a forwarding plane; and
a plurality of network elements of the forwarding plane each configured to periodically compose and transmit a control plane protocol message to every other network element of the forwarding plane, said control plane message comprising network, next-hop; and service information; wherein at least some of the network elements of the forwarding plane are provisioned with at least one policy to control routing of the network traffic based on at least one service, and configured to process the network traffic by the network elements of the forwarding plane based on the at least one policy.

12. The computer network of claim 11, wherein each policy specifies at least one service to be performed on the network traffic in a manner that is independent of a particular location in the computer network where said at least one service is available.

13. The computer network of claim 11, wherein said service information is in a Service SAFI component of the control plane message.

14. The computer network of claim 11, wherein each control message comprises reachability information for any service associated with an originator of said control message.

15. The computer network of claim 11, wherein each control message comprises state information for any service advertised in said control information.

16. The computer network of claim 11, wherein each network element of the forwarding plane is configured to process said control plane message based on a service import policy.

17. The computer network of claim 11, wherein each network element of the forwarding plane is configured to, upon receiving a control plane message indicating that a service previously available is no longer available, identify availability of a similar service in the computer network at another location the computer network.

18. The computer network of claim 17, wherein said network element is configured to direct network traffic to said other location if policy allows it.

19. The computer network of claim 17, wherein said network element is configured to drop network traffic mandated by policy to be routed subject to the service.

20. The computer network of claim 11, wherein inbound traffic received at a network element of the forwarding plane comprises a destination prefix and is decoupled from reachability information for a service associated with said inbound traffic.
